(19) United States
(12) Patent Application Publication
(10) Pub. No.: US 2026/0286125 A1
(43) Pub. Date: Sep. 24, 2026

(54) SUSTAINABLE AIRCRAFT FLOORPATH MARKING

(71) Applicant: STG Aerospace Limited, Cwmbran, Wales (GB)

(72) Inventors: Sean Patrick O'Kell, Cwmbran (GB); Andrew Jon Hallett, Cwmbran (GB); Tracy Suresh Vyas-Middlecoat, Cwmbran (GB)

(73) Assignee: STG Aerospace Limited, Cwmbran, Wales (GB)

(21) Appl. No.: 19/062,625

(22) Filed: Feb. 25, 2025

(30) Foreign Application Priority Data
Mar. 1, 2024 (GB) 2403007.4
Dec. 20, 2024 (GB) 2418780.9

(51) Int. Cl. C08L 69/00; B64C 1/18; B64D 25/00

(52) U.S. Cl. CPC C08L 69/00; B64C 1/18; B64D 25/00; C08L 2201/06; C08L 2207/20

(57) ABSTRACT

An aircraft emergency guidance assembly arranged to be mounted in an aircraft cabin includes a longitudinally extending layer of photoluminescent material and a housing arranged to protect the photoluminescent material. The housing comprises a polymeric cover arranged to cover the layer of photoluminescent material. The polymeric cover comprises at least 20% recycled material by mass; and a biodegradable additive arranged to promote biodegradation of the polymeric cover.

### CROSS-REFERENCE TO RELATED PATENT APPLICATIONS

The present application claims the benefit of and priority to both United Kingdom Application No. GB2403007.4, filed Mar. 1, 2024, and United Kingdom Application No. GB2418780.9, filed Dec. 20, 2024, the complete disclosures of both of which, including their specifications, drawings, claims and abstracts, are incorporated herein by reference in their entireties.

### BACKGROUND

This invention relates to aircraft emergency way guidance assemblies and to improvements in such assemblies.

It known to provide photoluminescent floorpath marking assemblies in aircraft cabins. Such assemblies are typically fitted to a floor of the aircraft cabin. In many cases an assembly in the form of a track is provided along at least one side of an aisle. In most examples a track is provided along both sides of the aisle in order to guide and direct passengers in case of an emergency from their seats to an emergency exit. Aircraft emergency way guidance assemblies may also comprise tracks or other markers on or along other surfaces—e.g. cabin walls or even seats.

Known aircraft emergency way guidance designs—including products produced by the applicant—often have a photoluminescent insert encased within an extruded polycarbonate sleeve or casing. Virgin polymers (i.e. newly-made, generally from fossil fuel fractions/not recycled polymers) are used to ensure compliance with strict aerospace standards, and—whilst these polymers are recyclable—in reality it has been found that they are often not recycled. This is in part due to additives and coatings (e.g. flame retardants) often required for compliance with aerospace requirements making the products potentially quite difficult to recycle even where there is a will to do so. A tough, highly transparent, polycarbonate (PC) plastic is often used, which is particularly harmful to the environment and can end up in landfill indefinitely. The carbon footprint associated with the production of 1 kg of polycarbonate is around 6 kg. Standard virgin PC also uses 100% fossil fuel derivatives for its production and does not include any recycled material. It will be appreciated that other polymers can also be used, e.g. polymethyl methacrylate (PMMA) and that similar environmental considerations apply.

It is an object of the invention to provide a more sustainable aircraft emergency guidance assembly.

### SUMMARY

According to an exemplary embodiment, an aircraft emergency guidance assembly arranged to be mounted in an aircraft cabin includes a longitudinally extending layer of photoluminescent material and a housing arranged to protect the photoluminescent material, the housing comprising a polymeric cover arranged to cover the layer of photoluminescent material. The polymeric cover includes at least 20% recycled material by mass and a biodegradable additive, with a loading of the biodegradable additive of between 0.01% and 0.20% by mass, and wherein the loading of the biodegradable additive is set such that light transmission of the polymeric cover is at least 80%.

According to another exemplary embodiment, an aircraft includes an emergency energy guidance assembly arranged to be mounted in an aircraft cabin that includes a longitudinally extending layer of photoluminescent material and a housing arranged to protect the photoluminescent material, the housing comprising a polymeric cover arranged to cover the layer of photoluminescent material. The polymeric cover includes at least 20% recycled material by mass and a biodegradable additive, with a loading of the biodegradable additive of between 0.01% and 0.20% by mass, and wherein the loading of the biodegradable additive is set such that light transmission of the polymeric cover is at least 80%.

### BRIEF DESCRIPTION OF THE DRAWINGS

The invention will now be described by way of example only with reference to the following Figures in which:

FIG. 1 is a cross section of an assembly in accordance with the invention;

FIG. 2 is a plan view of the assembly of FIG. 1;

FIG. 3 is a photograph illustrating eleven different extruded material samples for potential use as a casing in the assembly of FIG. 1;

FIG. 4 shows a cross-section of the assembly of FIG. 1 alongside a cross-section of a similar assembly with a different housing design;

FIG. 5 is a schematic of an aircraft in accordance with various aspects of the invention; and

FIG. 6 is a graph showing light transmission through housing covers with increasing bio-additive loading for 250 Lux incident light.

### DETAILED DESCRIPTION

According to a first aspect of the invention, there is provided an aircraft emergency guidance assembly adapted to be mounted in an aircraft cabin wherein the assembly comprises a longitudinally extending layer of photoluminescent material and a housing arranged to protect the photoluminescent material. The housing comprises a polymeric cover arranged to cover the layer of photoluminescent material, and the polymeric cover comprises: at least 20% recycled material by mass; and a biodegradable additive.

The recycled material may be recycled polymer, such that the polymeric cover comprises at least 20% recycled polymer by mass. Alternatively, the recycled material may be a polymer formed from waste monomers, such that the monomers are recycled to form a polymer.

The cover therefore both includes recycled material, and is itself biodegradable so reducing periods in landfill at end-of-life.

There is a prejudice in the art against using recycled materials in aircraft emergency guidance assemblies—and in particular in any part thereof covering light-emitting elements—due to the strict aerospace regulations relating to light output, lifespan/durability, flammability, and material traceability.

For example, the virgin polymer pellets for use in aerospace generally comprise a flame-retardant additive added by the manufacturer, so are typically more flame-retardant than typical recycled polymers, which were generally not all aerospace-grade initially, and may well not comprise a flame-retardant additive. Re-compounding of the recycled polymer would be needed to add the flame-retardant additive. Whilst that could be done, it was found that mixing a more flame-retardant virgin polymer with the recycled polymer provided a product of sufficient flame resistance without any need for re-compounding, so reducing processing costs. The virgin polymers are also generally clearer (better light transmission).

The inventors appreciated that using a mixture of virgin and recycled materials could increase the flame-retardant qualities of the material as compared to using entirely recycled material whilst still making use of a significant proportion of recycled material, so reducing waste and reducing the carbon footprint of the product.

There is a prejudice in the art against using mixed polymer streams for a casing, however, due to imperfect mixing often resulting in inclusions/defects in the casing, which can decrease the aesthetic properties of the assembly.

Using recycled polymers, a mixture of different grades of the selected polymer (e.g. polycarbonate) is generally to be expected between batches of recycled material, and even within a batch of recycled material (the materials generally flow slightly differently for different grades of polycarbonate, for example). Whilst there is a prejudice in the art against relaxing tolerances due to strict aerospace regulations, the inventors appreciated that a minor adjustment to tolerances to accept small variations would allow the carbon footprint of the product to be significantly decreased whilst still meeting the aerospace requirements. Due to the possible mixture of grades, there may also be imperfect mixing within the recycled polymeric component of the cover. As mentioned above, however, there is also a prejudice in the art against using mixed polymer types due to imperfect miscibility resulting in inclusions/defects which can be visible by eye when examining the final product. Even mixing a single, uniform, virgin polymer with a single, uniform recycled polymer has therefore not previously been done.

Whilst it would be hoped that the polymeric cover would be recycled, in reality, this is often not the case and end-of-life products may end up in landfill or equivalent. Biodegradability of the cover, and of the housing more generally, was therefore also considered by the inventors.

Most common plastics are not biodegradable-prior art polymeric housings or casings for photoluminescent aircraft emergency guidance assemblies will not break down over time, so remaining inert in landfill for centuries if not millennia.

“Biodegradable additives” are additives that increase the biodegradation of polymers by allowing microorganisms to use the carbon within polymer chains as a source of energy. The addition of biodegradable additives to a polymer can influence the mechanism of polymer degradation by changing the chemical and physical properties of polymers to increase the rate of degradation. In particular, biodegradable additives can change the polymer degradation process to a biodegradation process-instead of the polymer being degraded only by environmental factors, such as light or heat, biodegradable additives allow polymers to be degraded by microorganisms and bacteria as well.

There are three main types of biodegradable additives:

A. Carbohydrate-Based (e.g. Starch-Based) Additives

These additives can be directly consumed by microorganisms, so encouraging the microorganisms to eat the material of which they form a part. Microorganisms can directly attack and remove the carbohydrates from the plastic, leading to its degradation. Starch is a polymeric carbohydrate, and is a common biodegradable additive of this type. The presence of a continuous starch phase allows direct consumption of the plastic by microorganisms because the material becomes more hydrophilic. Various mono- and poly-saccharides can also be used, among other options. These additives may assist in breaking down the long polymer chains of the plastic with which they are combined into easily degradable smaller compounds for the microbes to digest, as well as being available for digestion themselves.

### B. Bioaugmentation Additives

“Bioaugmentation” is the direct addition of certain microbial strains to a polymeric material, and serves to increase the biodegradability of plastics—the additive is or comprises the microorganisms themselves. Bioaugmentation has been used to enhance the rate of degradability of already compostable plastics, but not all plastics are compostable.

### C. Pro-Oxidant Additives

These additives increase the rates of thermo-oxidation and photo-oxidation, resulting in a larger proportion of low molecular weight compounds which can be more efficiently extracted by microorganisms. The carbon is made more available for microorganisms. Transition metal complexes, e.g. based on iron (Fe), manganese (Mn), and cobalt (Co), are examples of pro-oxidant additives. The heat- or light-induced oxidation (and therefore fragmentation of the polymer chains) would happen naturally as a plastic degrades in the open environment, but the presence of a pro-oxidant additive accelerates the process. There is however some controversy about whether or not this type of additive leads to an increased production of environmentally-harmful microplastics.

A given commercial additive may include a mixture of two or more of the above types. In various embodiments, carbohydrate-based or starch-based additives may be favored.

In general for aerospace applications, in which a relatively long lifespan of the product is desirable, carbohydrate-based or starch-based additives may be favored as these have no significant effect on the material until or unless it is exposed to appropriate microbes, and suitable conditions (e.g. moisture levels) for those microbes-such conditions are very unlikely to occur in service, but would be expected in landfill. Bioaugmentation additives may be avoided as these may lead to breakdown of the plastic during service. However, in many cases the microbes may be dormant until the product reaches landfill, as the right conditions (e.g. moisture levels) may not be present in service. Similarly, pro-oxidant additives may increase oxidation rate of the material in service, but this process may greatly accelerate in the generally warmer and wetter conditions of landfill. It will be appreciated that bioaugmentation additives and pro-oxidant additives can therefore still be suitable.

The use of biodegradable additives therefore provides a “greener”, more environmentally-friendly, product, as the polymer is made available for use by microorganisms and its dwell-time in landfill (if the product is not recycled) is reduced significantly. However, the use of such a biodegradable additive in a polymeric material may reduce the light transmission of the polymeric material.

This potential reduction in light transmission caused by the biodegradable additive is generally seen as an entirely negative factor, leading to a prejudice in the art against using biodegradable additives in any layer covering a light-emitting element (such as the photoluminescent material layer described herein). However, the inventors appreciated that this “frosting” or clouding of the polymeric material due to the addition of the biodegradable additive could be used to counteract the negative aesthetic effect of the use of recycled materials, such as recycled polymers/mixed polymers. In particular, at the right loading level, the biodegradable additive was found to frost the casing material sufficiently to disguise defects/inclusions visually, whilst still letting through sufficient light to meet output requirements. Combined usage of two materials previously avoided in the making of such covers-recycled materials and biodegradable additives—therefore provides a synergy.

As a higher loading of biodegradable additive further reduces light transmission of the polymer, the inventors appreciated that the loading should be maintained at a relatively low percentage to ensure sufficient transmission and performed extensive testing to find suitable loading levels.

It is an object of the invention to provide an improved assembly which is robust, durable, and meets required performance characteristics. It is an advantage of the invention that the casing makes use of recycled materials, so reducing the use of fossil fuels/petrochemicals, whilst still achieving an assembly that meets the required performance characteristics. A further advantage is that the product is itself biodegradable, so being more environmentally-friendly after its service life is complete.

It will be appreciated that in some embodiments the assembly may be connected to additional adjacent assemblies to form a track extending along an aisle of an aircraft cabin.

The recycled material may be or comprise a recycled polymer—i.e. a material made from pre-existing end-of-life or waste (e.g. industrial offcuts) polymers. The polymeric cover may comprise at least 25%, 30%, 35%, 40%, 45%, 50%, or 55% recycled polymer by mass. The polymeric cover may comprise between 20% and 60% recycled polymer by mass. The polymeric cover may comprise between 30% and 60% recycled polymer by mass.

The recycled polymer may be recycled polycarbonate. The recycled polymer may be colorless, and optionally may be a colorless polycarbonate.

The polymeric cover may comprise at least 45% virgin polymer. The virgin polymer may be polycarbonate.

Alternatively or additionally, the recycled material may be or comprise a polymer formed from monomers generated as a waste product. In embodiments in which all of the recycled material is a polymer formed from monomers generated as a waste product rather than recycled polymer, the polymeric cover may comprise more recycled material by mass than in embodiments using recycled polymer. For example, the polymeric cover may comprise at least 55%, 60%, 65%, 70%, 75%, 80%, or 85% recycled material by mass. In some embodiments, the polymeric cover may comprise at least 88% recycled material by mass.

In embodiments in which the recycled material is a polymer formed from monomers generated as a waste product, the polymeric cover may comprise 70 to 95% recycled material by mass, optionally 80 to 95% recycled material by mass, and further optionally 85-90% recycled material by mass. The polymeric cover may comprise between 0.01% and 0.10% biodegradable additive by mass. For example, the polymeric cover may comprise 85% or 88% recycled material by mass.

The recycled material may be a recycled colorless polycarbonate.

For any recycled material used for the polymeric cover, the loading of the biodegradable additive may be between 0.01% and 0.2% by mass, or between 0.01% and 0.1% by mass (mass of the cover material), optionally between 0.09% and 0.10% by mass, and further optionally between 0.04% and 0.06% by mass. The loading of the biodegradable additive may be 0.05% by mass. The loading of the biodegradable additive may be 0.05±0.0025% by mass.

The polymeric cover may comprise 45 to 55% recycled polymer by mass and between 0.01% and 0.1% (and optionally around 0.05%) biodegradable additive by mass. Such a polymeric cover may comprise 45 to 55% virgin polymer by mass. The virgin polymer may be Makrolon® 6717, LEXAN ML3290, or an aerospace regulations-compliant polycarbonate, for example. The virgin polymer may be more flame-retardant that the recycled polymer.

The polymeric cover may comprise or consist of 50±5% recycled polymer, between 0.01% and 0.1% (and optionally 0.05±0.0025%) biodegradable additive, and 50±5% virgin polymer, by mass.

The bio-degradable additive may be or comprise a carbohydrate-based or starch-based additive. The biodegradable additive may be a BioSphere 201 grade biodegradable additive, and optionally may be the BioSphere 201J biodegradable additive. BioSphere 201J may be used at a loading of between 0.01% and 0.1% by mass, and optionally of 0.05% by mass, and further optionally of 0.05±0.0025% by mass.

Light transmission through the polymeric cover may be at least 80%, and optionally at least 85%, of incident light.

The loading of the biodegradable additive in the polymeric cover may be set by adding biodegradable additive until light transmission through the polymeric cover drops to 90%, or 85%, of incident light

An underside of the housing—e.g. a side of the housing furthest from the cover—may be arranged to be secured to the floor of an aircraft cabin.

The cover may comprise at least a first area through which light emitted by the photoluminescent material is transmitted. The upper surface of the cover may comprise at least a second area through which light from photoluminescent material is not transmitted.

The surface of the assembly attended to be visible in use—which is often the upper surface thereof—may be referred to as a presentation surface. The presentation surface may include first areas through which light emitted by photoluminescent material is transmitted. The presentation surface may additionally comprise second areas through which light from photoluminescent material is not transmitted. At least the majority of the presentation surface may be provided by the cover.

The assembly may be adapted to be connected to, or aligned with, a further assembly (and optionally to multiple further assemblies) to form a track adapted to be fitted to a floor of an aircraft cabin and to extend along an aisle of an aircraft cabin.

The polymeric cover may comprise, or at least substantially consist of, one or more colorless polymers. Optionally, the one or more colorless polymers may be selected from polypropylene, polycarbonate, polymethyl-methacrylate, and polyurethane. At least one of the polymers is either a recycled polymer, or a polymer formed from monomers generated as a waste product.

The polymeric cover—or at least a bulk material thereof—may comprise a single polymer type, with a portion of the polymer being recycled and a portion of the polymer being virgin. For example, recycled and virgin polycarbonate may be used for one cover, and recycled and virgin polyurethane may be used for another cover, but a given cover may not mix polyurethane and polycarbonate within its bulk material. Material properties may be better-controlled, for example with the materials being more miscible and/or more predictable in extrusion, when limited to a single polymer type. The housing may similarly comprise a single polymer type, at least in its bulk material.

For both the cover and the housing, one or more coatings may be added—e.g. a polymethyl methacrylate (PMMA) protective coating on an upper surface—after the part has been formed, e.g. by extrusion of the bulk material. It will be appreciated that these coatings may be of a different polymer type, but do not affect extrusion properties as they are only added later; the “single polymer type” referred to above therefore refers to the body/main material of the cover or housing, and excludes any coatings applied thereto. For example, the polymeric cover comprising only a single polymer type in its bulk material (e.g. polycarbonate) may have a coating of a different polymer type applied thereto (e.g. PMMA).

The longitudinally extending layer of photoluminescent material may be slidably removable from the housing. At least one sealed end of the housing may need to be cut (across the width of the housing) to allow the photoluminescent layer to be slid out, along the (longer) length of the housing.

The housing may be a single-piece housing made of the same material, with the cover forming an integral part of the single-piece housing. The housing may take the form of a sleeve.

Alternatively, the housing may comprise at least two parts made of different materials, the at least two parts optionally being or comprising the cover; and a base.

The base may be located on the far side of the photoluminescent material from the cover, and optionally also along the sides of the photoluminescent material (potentially meeting the cover in edge regions of the layer of photoluminescent material. The base is arranged to leave a surface of the photoluminescent material arranged to be visible in use (generally an upper surface) uncovered, with the cover completing the housing. Whilst light to the photoluminescent material for charging thereof and light emitted by the photoluminescent material to perform its afterglow function must pass through the cover, such light does not need to pass through the base. The base may have a lower light transmission than the cover.

The base may be polymeric, and may comprise at least 50% recycled material by mass. The base may comprise at least 50% recycled polymer by mass. The percentage of recycled polymer may be higher in the base than in the cover. The base may comprise a biodegradable additive. The loading of the biodegradable additive may be higher in the base than in the cover.

According to a second aspect of the invention, there is provided an aircraft having an aircraft cabin, the aircraft cabin comprising an aircraft emergency guidance assembly as described with respect to the first aspect.

The aircraft cabin may comprise at least one track extending along an aisle of the aircraft cabin, the track comprising a plurality of emergency guidance assemblies as described with respect to the first aspect connected together.

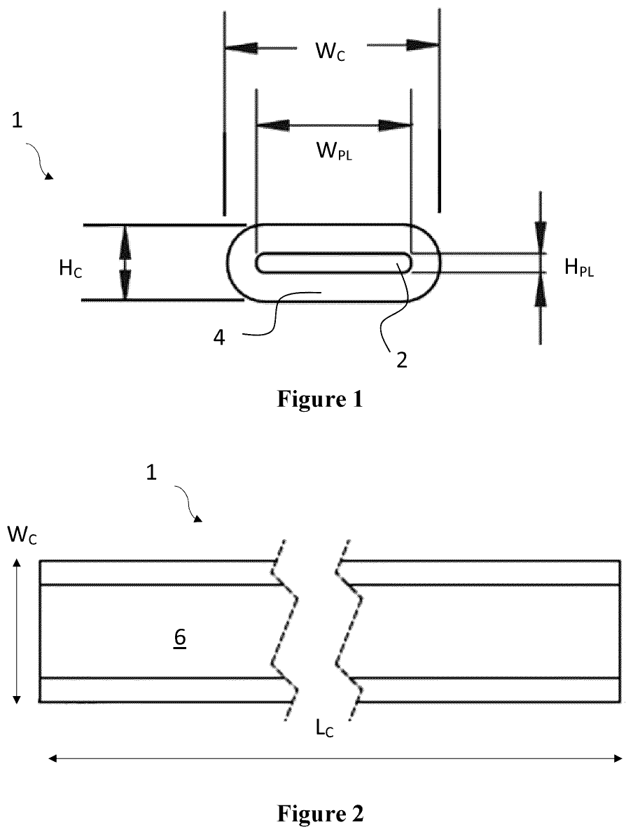

FIG. 1 of the appended drawings illustrates a cross-section of an aircraft emergency guidance assembly 1 in accordance with an aspect of the invention. The aircraft emergency guidance assembly 1 is adapted to be mounted in an aircraft cabin. The assembly 1 comprises a longitudinally extending layer 2 of photoluminescent material and a housing 4 surrounding and protecting the photoluminescent material 2. In the embodiment shown, the housing 4 is in the form of a sleeve, or casing 4.

The assembly 1 has a height indicated as HC and the assembly has a width WC, this height and width being the external dimensions of the casing 4. In this embodiment the height of the assembly is around 4 mm; in various implementations, the height, HC, may be in the range from 1 mm to 8 mm. In this embodiment, the width of the assembly 1 is 11 mm; in various implementations, the width, WC, may be in the range from 8 mm to 40 mm, and may for example be 11 mm, 18 mm, 23 mm or 36 mm.

In the illustrated embodiment, the assembly 1 is arranged to be installed in a channel 6 in a carpet, or other flooring material, of an aircraft cabin.

The layer of photoluminescent (PL) material 2 is surrounded by the casing 4, fitting in a gap or channel therewithin. An upper surface of the assembly 1, in the orientation shown, is intended to be visible in use. The upper portion of the casing 4 therefore covers the PL material 2, and may be referred to as a cover 4a—the light emitted by the PL material 2 has to pass through the casing 4—and more specifically through the cover 4a—to be visible.

In the embodiment shown in FIG. 1, the height of the PL layer 2 is around 1 mm, for example being 1 mm+0.15 mm. The thickness of the casing 4 on either side of the PL layer 2 may therefore be around 1.5 mm, and optionally in the range from 1.40 to 1.75 mm.

In various implementations, the height, HPL, may be in the range from 0.5 mm to 3 mm.

A carpet installed in an aircraft typically has a height from 2 mm to 6 mm. Most carpets have a height of from 3 mm to 4 mm. It will be appreciated that if the height HC of the assembly 1 is greater than the height of the carpet then the assembly 1 may be a trip hazard. It is therefore desirable that the height HC of the assembly 1 is therefore no more than 4 mm. In embodiments in which the assembly 1 is mounted onto a hard floor, the housing 4 may be arranged to provide sloping wings to reduce the potential trip risk.

The length of the assembly 1, Lc, may be a maximum of 2 metres (e.g. 2000±2 mm)—a maximum length may be set for portability. The dashed zig-zag lines in FIG. 2 are used to indicate a length that may vary widely—for example being between 10 cm and 2 m. Multiple assemblies 1 may be connected together to form a track longer than any one individual assembly 1.

As shown in FIG. 2, the assembly 1 has an upper surface 6—the height HC is from the base of the assembly 1 to the upper surface 6.

It will be appreciated that the base of the assembly 1—i.e. the underside of the casing 4 in the embodiment shown in FIGS. 1 and 2—may be adapted to be securable to the floor of an aircraft cabin 20 in use. The base of the assembly 1 may be secured to, or mounted on, the floor by conventional means.

The casing 4 extending over the photoluminescent material 2 is formed of a material that is scratch-resistant, flame-retardant, and at least partially transparent or translucent.

In the embodiment 1 being described, the casing 4 is in the form of a sleeve, and is formed by extrusion. The PL material layer 2 may be co-extruded within the sleeve 4, or may be slid into position within the sleeve 4 after the sleeve has been formed. Preferably, the sleeve 4 is continuous around its cross-section, with the only openings being at either end. The sleeve 4 may be sealed once the PL material 2 is correctly-located within it, optionally using a UV-cured adhesive to make a hermetic seal.

In the embodiment 1a shown in FIG. 4 alongside an image of the embodiment 1 described above, the sleeve casing 4 is replaced by a different kind of housing 4, comprising two parts 4a, 4b arranged to be connected together. In particular, the housing 4 of this embodiment 1a comprises a cover 4a which lies above the PL layer 2 (in the orientation shown), covering it, and a base 4b lying below the PL layer 2 (in the orientation shown), and also enclosing the sides of the PL layer 2. The cover 4a and base 4b are bonded together to form the housing 4 which encloses the PL layer 2. In other embodiments, the cover 4a may include portions extending around the sides of the PL layer 2, and the base 4b may be at least substantially flat. A multi-part housing with more than two parts 4a, 4b may be provided in other embodiments, for example having separate side portions arranged to join a cover 4a to a base 4b and to protect the sides of the PL layer 2.

It will be appreciated that light for charging the PL material 2 and light emitted by the PL material 2 must both pass through the part of the housing 4 covering the PL layer. In the first embodiment 1 described above, the housing 4 is a single-piece casing 4 all made of the same material; the selected material is chosen for its good light-transmission properties, among other requirements. By contrast, in the second embodiment 1a being described, the different parts 4a, 4b of the housing 4 may be made of different materials-only the cover 4a is required to have its good light-transmission properties. Whilst the base 4b may have the same requirements in terms of flammability, temperature resistance, and optionally also durability (although it will be appreciated that the base 4b may be more shielded from impacts in use), the optical properties can be less strictly controlled. In particular, a larger percentage of recycled material may be used for the base 4b (optionally with an added flame-retardant) and/or a higher loading of biodegradable additive may be used (as clouding of the material is not a problem). The base 4b may be made of 100% recycled material (with any optional additives). It will be appreciated that properties of the cover 4a and base 4b such as thermal expansion/contraction may be carefully matched, whilst allowing the optical properties to differ.

The casing 4 and the cover 4a are each made of polycarbonate in the embodiment being described. In particular, in this embodiment the material of the casing 4 is a blend of recycled and virgin polycarbonates and the recycled material is therefore a recycled polymer, and more specifically is recycled polycarbonate-more specifically being composed of 50% Makrolon® 6717 (virgin aerospace-suitable polycarbonate) and 50% rechipped polycarbonate (recycled polycarbonate). It will be appreciated that different virginpolymers, e.g. LEXAN ML3290, may be used in other embodiments.

In alternative or additional embodiments, the recycled material is or comprises a polymer derived from monomers that are considered as waste or processing residue from other industrial or chemical processes. Unlike standard virgin polymers which use 100% fossil fuel derivatives for their production and do not include any recycled material, the polymers made from waste monomers do not use additional fossil fuel resources, instead reclaiming monomers that would otherwise end up in landfill or otherwise polluting the environment. The recycled material may therefore be a recycled polymer (being formed from waste polymer material, without breaking the polymer chains excessively) or a polymer made from waste monomers (forming new polymer chains). The waste polymer or monomer material may be a by-product of an industrial process, pre-consumer waste (e.g. manufacturing offcuts), and/or post-consumer waste. In some cases, the term “recycled polymer” may be used to mean a recycled material formed from either of these two options, but a distinction is drawn here for clarity. A mixture of recycled polymer(s) and polymer(s) made by recycling waste monomers may be used in some embodiments.

In order to meet the aerospace industry's requirements on material traceability, the recycled polycarbonate is product manufacturing offcut/excess (industrial waste that would normally be disposed of/go to landfill) as opposed to post-consumer waste; batch numbering and recording of the recycled polymer can therefore be implemented, with each batch of re-chipped material being assigned its own part and batch numbers. Due to the nature of the re-chipped material, it is often not possible to determine its exact makeup. However, all the possible grades of polycarbonate (or other polymer, as appropriate) that might be included can be noted for each batch, and the grade with the weakest performance against a given aerospace requirement may be used as the limiting case for testing. For example, in a batch of recycled polycarbonates, Calibre 6303/3 grade may be the least flame-retardant polycarbonate likely to be included in the re-chipped material. Therefore, a sample with 50% Makrolon® 6717 and 50% Calibre 6303/3 re-chipped polymer may be used as the test sample for flammability requirements. A different sample may be used for testing of another characteristic for which the Calibre 6303/3 grade is not weakest.

The use of re-chipped polycarbonate was found to increases the likelihood of forming inclusions/defects in the extruded sleeve 4, however, due to the different flow properties. Inclusions generally form when the melted plastic is compressed and folds upon itself—this can be rectified e.g. by adjusting the distance between the extruder barrel and the dye tool, but the correct distance, flow-rate, and temperature combination (among other factors) can vary between batches when variable recycled material is used, meaning that a single setting cannot be relied upon and more imperfections are likely to slip through.

Re-chipped material is generally unevenly sized compared to virgin grade pellets, and so has a possibility of melting inconsistently in the extruder and causing malformations in the extruded form as a result even if the material composition is uniform. As this material has generally also been extruded once already, there is a possibility of the polycarbonate discolouring when it is re-extruded.

The use of a frosting agents to hide such inclusions/defects is one option to improve aesthetics—this would deleteriously reduce light transmission, however, so a balance must be struck between aesthetics and luminance.

It was found that careful use of a biodegradable additive, with precise testing and control of the loading, can provide a frosting effect sufficient to hide inclusions whilst still letting sufficient light through for the assembly to fulfil its purpose, also increasing the sustainability of the product.

In the embodiments being described, with 50% Makrolon® 6717 and 50% re-chipped polycarbonate, a 0.05% loading (by mass) of a Biosphere biodegradable additive was found to frost the assembly 1 suitably to disguise any inclusions whilst retaining light transmission above 80% of the incident light (under both 250 Lux and 40 Lux tests).

A marginal colour shift of the assembly 1 was noted—this can be compensated for in a printing process so as to match a desired colour of the finished product if desired.

A variety of combinations were tested before arriving at this combination of materials and additive loading, for example as shown in Table 1. Each sample was subjected to a flammability test (to check for fire resistance) and a Lux test (to check light transmission).

For the flammability test, each sample was tested to see if it met EASA (European Union Aviation Safety Agency) and FAA (Federal Aviation Administration) flammability requirements as stated below:

Horizontal Test: CFR/CS-25.853(a) App. F Part I (a)(1)(iv)
The flame must be applied for 15 seconds and then removed. The material may not have an average burn rate greater than 64 mm (2.5 inches) per minute when tested horizontally.

Vertical Test: CFR/CS-25.853(a) App. F Part I (a)(1)(ii)
The flame must be applied for 12 seconds and then removed. The material must be self-extinguishing when tested vertically. The average burn length may not exceed 20 cm (8 inches), and the average flame time after removal of the flame source may not exceed 15 seconds. Drippings from the test specimen may not continue to flame for more than an average of 5 seconds after falling.

For the light transmission test, the samples were tested in order to determine if enough light could pass through the material to allow the PL material to charge, and the PL luminance to be seen. The requirements are stated below:

Measure the effect of the track on light transmission with 250 Lux and then with 40 Lux. The track must not reduce the light transmission by more than 20%:
250 Lux exposure: measurement: no less than 200 Lux;
40 Lux exposure: measurement: no less than 32 Lux.

TABLE 1
casing materials

| | | Notes on | Flame | Lux |
|---|---|---|---|---|
| # | Composition | extruded product | Test | Test |
| Control | 100% Makrolon ® | Standard - extrudes | Pass | Pass |
| | 6717 | clear; good light | | |
| | | transmission | | |
| 1 | Makrolon 6717 + | White in appearance - | Pass | Fail |
| | 1% Biosphere | light transmission | | |
| | biodegradable | reduced unacceptably | | |
| | additive | | | |
| | (“Biosphere”) | | | |
| 2 | Makrolon 6717 + | Translucent white - | Pass | Fail |
| | 0.5% Biosphere | light transmission | | |
| | | reduced unacceptably | | |
| 3 | Makrolon 6717 + | Slight lack of clarity, | Pass | Pass |
| | 0.1% Biosphere | light transmission | | |
| | | potentially acceptable | | |
| 4 | Mitsubishi Durabio | Completely Opaque | Fail | Fail |
| | D3740IR | white in appearance - | | |
| | | light transmission | | |
| | | reduced unacceptably | | |
| 5 | LG ER1000MH-NP | Extruded clear - | Fail | Pass |
| | 60% Post-Consumer | light transmission | | |
| | Recycled (PCR) PC | good | | |
| 6 | LG ER1000MH-NP | Extruded slightly | Pass | Pass |
| | 60% PCR-PC + | milky, light | | |
| | 1% KSS-FR Flame | transmission | | |
| | retardant | acceptable | | |
| | (“KSS-FR”) | | | |
| 7 | LG PC1300LZ-10 | Extruded clear - light | Fail | Pass |
| | Mass Balanced PC | transmission good | | |
| 8 | LG PC1300LZ-10 | Extruded very | Pass | Pass |
| | Mass Balanced + | slightly milky, | | |
| | 1% KSS-FR | light transmission | | |
| | | likely to be acceptable | | |
| 9 | 50% Makrolon 6717 + | Extruded clear - light | Pass | Pass |
| | 50% Rechipped Clear | transmission good, but | | |
| | Polycarbonate | inconsistent particle | | |
| | | size of re-chipped | | |
| | | material causes white | | |
| | | streaks in extruded | | |
| | | material | | |
| 10 | Makrolon 6557 RE | Extruded milky | Pass | Pass |
| | Mass Balanced PC | with bubbles in it - | | |
| | | light transmission | | |
| | | potentially acceptable, | | |
| | | but bubbles are a risk | | |
| | | for use at low | | |
| | | pressure (aerospace) | | |

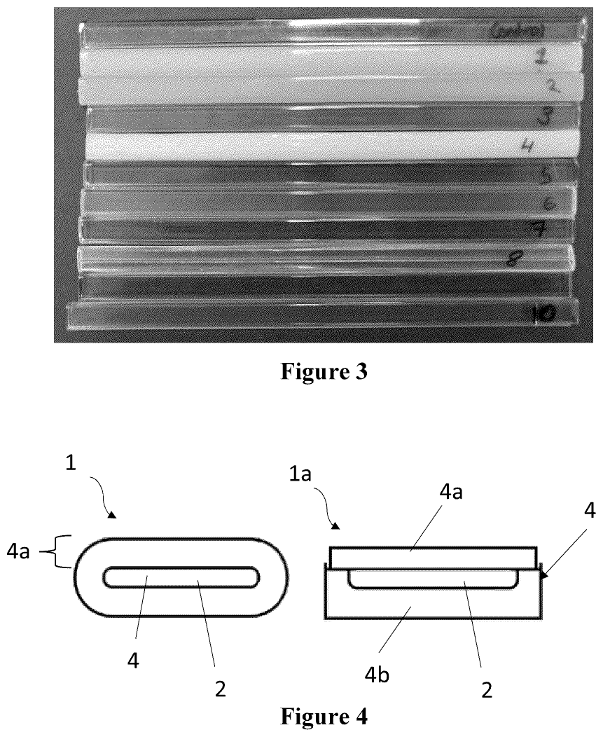

FIG. 3 is a photograph of these eleven samples, arranged with the control sample at the top and in numerical order from (1) to (10) thereafter.

As can be seen, even at a loading of just 0.1% in virgin aerospace polymer, the presence of the Biosphere biodegradable additive provided a frosting effect, reducing light transmission.

The samples which failed either or both tests were then discounted, leaving the Control and Samples 3, 6, 8, 9 and 10. These samples were then further tested for other requirements including wear resistance (both footfall and galley cart movement), temperature resistance, and fluid resistance, and all found to meet the required standards. The samples were also tested for print adhesion, for aesthetic purposes.

Of these, Samples (6)—60% post-consumer recycled polymer—and (9)—50% re-chipped industrial waste recycled polymer—have the highest sustainability impact in terms of manufacture. Addition of a flame-retardant was required for Sample (6) to pass the flame test, however—this additive reduces the light transmission to some extent, so adding a biodegradable additive too might reduce light transmission too far. Sample (9) was therefore chosen as the starting point for testing use of the biodegradable additive.

As can be seen in Table 2 below, using a 0.1% loading of Biosphere biodegradable additive with 50% Makrolon 6717+50% rechipped polycarbonate (Sample D, below) as opposed to with 100% Makrolon 6717 (Sample 3, above) caused the sample to fail the light transmission test—lower loadings were therefore tested to arrive at the desired light transmission. Frosting with a frosting agent (Sample E) was also found to suitably disguise inclusions, but without the sustainability benefit of the biodegradable additive.

TABLE 2
testing additive loading

| | | Flame | Lux test | Lux Test Light |
|---|---|---|---|---|
| # | Composition | test | Pass/Fail | Transmission |
| Control | 100% Makrolon 6717 | Pass | Pass | 89.6% |
| A | 50% Makrolon | Pass | Tested as limiting case | |
| | 6717 + 50% | | for flame test only | |
| | Calibre 603/3 | | | |
| B | 50% Makrolon | Pass | Pass | 89.2% |
| | 6717 + 50% | | | |
| | rechipped | | | |
| | polycarbonate | | | |
| C | 50% Makrolon | Pass | Pass | 86.8% |
| | 6717 + 50% | | | |
| | rechipped | | | |
| | polycarbonate + | | | |
| | 0.05% Biosphere | | | |
| | biodegradable | | | |
| | additive | | | |
| D | 50% Makrolon | Pass | Fail | 76.6% |
| | 6717 + 50% | | | |
| | rechipped | | | |
| | polycarbonate + | | | |
| | 0.1% Biosphere | | | |
| E | 50% Makrolon | Pass | Pass | 86.4% |
| | 6717 + 50% | | | |
| | rechipped | | | |
| | polycarbonate + | | | |
| | 1% LumiPlas | | | |
| | LD7820 frosting | | | |
| | agent | | | |

The use of 50% recycled (rechipped) polycarbonate along with a virgin polycarbonate (in this case, Makrolon® 6717, although it will be appreciated that other aerospace-compliant polycarbonates may be used in other implementations), was therefore found to be effective. Both polycarbonates are colourless, so not affecting the colour of incoming or outgoing light.

In other implementations, a different suitable polymer type may be used. For example, polymethyl methacrylate, polyurethane, or polypropylene may be used for the cover 4a. A suitable polymer may have good light-transmission, be flame retardant, be durable/robust, and have good clarity. Colourless polymers may generally be favoured, although a coloured layer may be favoured in some implementations, for example to provide a desired surface colour in use.

In most implementations, the polymeric cover 4a comprises only polymers of a single type—e.g. just polycarbonates or just polyurethane—with a portion of the material being recycled and a portion of the material being virgin. Avoiding mixing of polymer types may facilitate control of material properties, both during manufacture (e.g. improving miscibility) and in use (e.g. providing better matching of expansion coefficients with temperature changes). However it will be appreciated that certain polymer type mixes may be suitable for reliable and predictable extrusion; e.g. certain polycarbonate/PMMA mixes. The skilled person would therefore appreciate that the avoidance of polymer type mixtures is a general guideline rather than a strict rule.

In various implementations, the polymeric cover 4a may comprise less recycled polymer by mass than the 50% mentioned above—for example around 25%, 30%, 35%, 40%, or 45%. In other implementations, the polymeric cover 4a may comprise at least 50% recycled polymer by mass, and may optionally comprise at least 55% recycled polymer by mass. In various implementations, the polymeric cover 4a comprises at least 40% or 45% virgin polymer by mass, and may comprise 50±10% or 50±5% virgin polymer by mass. In various implementations, the polymeric cover 4a comprises at least 40% or 45% recycled polymer by mass, and may comprise 50±10% or 50±5% recycled polymer by mass.

In the embodiment shown in FIG. 1, the housing 4 is a single-piece housing 4, with the cover 4a being integral with the rest of the housing 4—the housing 4 effectively forms a sleeve surrounding the photoluminescent (PL) layer 2. The entirety of the housing 4 is made of the same material in such embodiments. In other embodiments, such as that shown in the right-hand portion of FIG. 4, the housing 4 comprises multiple parts, for example two separable parts:
(i) the cover 4a arranged to lie above the PL layer 2; and
(ii) a base 4b arranged to lie below the PL layer 2.

It will be appreciated that “above” and “below” are defined here with respect to a typical orientation of a floorpath marking in use, where the upper face of the guidance assembly 1 is the face intended to be seen by users. The cover 4a may therefore be described as providing a presentation surface, irrespective of orientation, with the base 4b lying on the far side of the PL layer 2 from the cover 4a, and optionally joining the cover 4a at the edges of the PL layer 2.

In the second embodiment shown in FIG. 4, the side of the PL layer 2 are enclosed by portions of the base 4b. In other embodiments, the cover 4a may curve down to protect the sides, and/or separate side pieces of the housing 4 may be provided. In still other embodiments, the cover 4a itself may be split into multiple pieces. In embodiments with a housing 4 comprising multiple parts, one or more of the parts may be made from different materials. For example, in some embodiments, the percentage of recycled polymer, and/or the loading of the biodegradable additive, may be higher in the base 4b (and optionally in any side pieces) than in the cover 4a. For example, one or more parts of the housing 4 other than the cover 4a may comprise at least 50%, 55%, 60%, 65%, 70%, or 75% recycled polymer by mass, and may optionally be 100% recycled polymer (i.e. entirely recycled polymer, except for small percentages of any additives). The optical property requirements are generally more stringent for the cover 4a than for the base 4b (and any side pieces of the housing 4), so allowing use of a less clear material for the base.

The loading of the biodegradable additive in the base 4b (and optionally in any side pieces of the housing 4) may be much higher than that in the cover 4a, for example by a factor of ten, twenty, or fifty. For example, the loading of the biodegradable additive in the base 4b may be around 1%, 1.5%, 2%, or 2.5% by mass of the polymeric part 4b.

In the cover 4a, the loading of the biodegradable additive is generally kept lower to ensure sufficient clarity/minimal light-blocking of the cover material, so allowing the PL layer 2 to be charged by incident light unimpeded, and allowing the PL glow of the material 2 to travel through the cover 4a unimpeded.

In particular, in various embodiments, light transmission through the polymeric cover 4a is at least 80%, and optionally at least 85%, of incident light (which may be daylight spectrum light, or at least light in the range(s) of absorption by the photoluminescent material and emission by the photoluminescent material). For example, on exposure to 40 Lux light on a first surface of the cover 4a, at least 32 Lux must emerge from the opposing face of the cover 4a. In various embodiments, the loading of the biodegradable additive in the polymeric cover 4a may be set by adding biodegradable additive until light transmission through the polymeric cover drops to 95%, 90%, 85%, or 80% of incident light. The threshold level may be set higher (higher transmission) when a coloured film or printed pattern is to be used on or adjacent to the cover 4a, to ensure sufficient light transmission even when another component blocks some of the light.

In the examples described above, the selected biodegradable additive is a BioSphere 201 grade biodegradable additive, and more specifically is the BioSphere 201J biodegradable additive. In other implementations, a different biodegradable additive may be used, for example one or more of the products available from EcoPure®. It will be appreciated that the choice of additive may depend on the particular polymer(s) of the housing 4, among other factors, and that any suitable additive may be used provided that compliance with the applicable aerospace requirements is ensured.

The loading of the biodegradable additive in the housing 4, or at least in the cover 4a, is 0.05% by mass in some embodiments, and may be 0.05±0.0025% biodegradable additive by mass. In other embodiments, a loading of at least 0.02% and not more than 0.20%, and optionally not more than 0.12%, may be used, the loading optionally being in the range from 0.03% to 0.10% or from 0.04% to 0.09%. A trade-off between biodegradation rate and light transmission of the material may be considered in setting the loading. A higher loading of the biodegradable additive (or “bio-additive”, for brevity) may be possible for the same light transmission when the percentage of virgin polymer is higher (as the polymeric material itself may be clearer, so allowing for more clouding due to the additive whilst still meeting optical performance targets). The partial blocking of light due to the bio-additive advantageously also provides some frosting which may disguise cosmetic imperfections due to the use of recycled material.

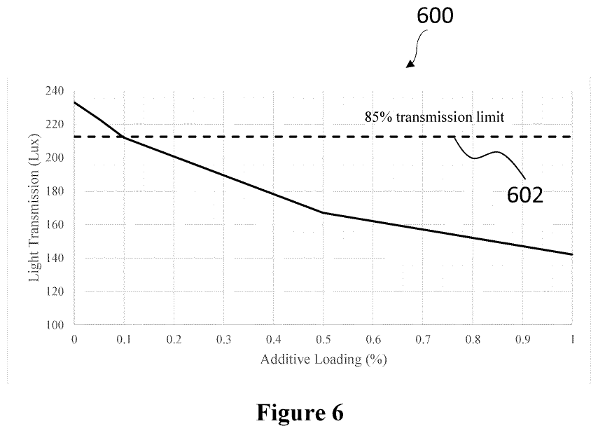

FIG. 6 is a graph 600 showing light transmission through polycarbonate housing covers 4a with 50% virgin polycarbonate derived directly from fossil fuel sources/not from waste monomers (Makrolon® 6717), 50% recycled polycarbonate, and increasing bio-additive loadings (from 0 to 1% by mass of BioSphere 201J biodegradable additive) for 250 Lux incident light. Initial tests indicate that effects on light transmission/clouding are similar for various currently commercially available bio-additives, so data for this additive only are provided by way of example.

As can be seen from the graph 600 of FIG. 6, the light transmission of the resultant polymeric material drops quite rapidly at first as the loading of the biodegradable additive is increased from zero, with the rate of loss of clarity with increasing loading decreasing as loading increases. A dashed line 602 indicates 85% of the incident 250 Lux (212.5 Lux), which is set as a threshold in this example. A 0.10% loading of the bio-additive caused the transmission to drop just below the set threshold, so a lower loading would be selected to meet the optical requirements for the cover 4a.

In embodiments in which the aircraft emergency guidance assembly 1 is used as a floorpath marking, an underside of the housing 4 (e.g. the base 4b) is arranged to be secured to the floor of an aircraft cabin 20. Light transmission through the base 4b may therefore be irrelevant—a cloudy, or even opaque, material may therefore be used for the base 4b when the base 4b is a separate part from the cover 4a (albeit generally firmly fastened thereto, either directly or via intervening side portions of the housing 4). Even in embodiments in which the base and cover are integrally formed to make a one-piece housing, material composition may vary between the base and the cover, e.g. by careful co-extrusion of two or more materials, or by any suitable technique known in the art.

In such embodiments, the assembly 1 is generally adapted to be connected to a further assembly 1 to form an elongate track adapted to be fitted to the floor of an aircraft cabin 20 and to extend along an aisle 21 of the aircraft cabin towards an emergency exit.

In various embodiments, a lower surface of the housing 4 (e.g. a side of the base 4b furthest from the cover 4a in multi-part housings) has an image or pattern printed thereon, for example to label the product name, type, size, batch number, and/or other details. The base 4b/lower part of a single-piece housing 4 may be made entirely opaque by such printing in some such embodiments. In particular in embodiments in which the housing 4 is a single piece, the entire surface of the housing 4 may therefore be arranged to be suitable for use as a printing substrate.

In various embodiments, the cover 4a may comprise at least a first area through which light emitted by the photoluminescent material 2 is transmitted and at least a second area through which light from photoluminescent material 2 is not transmitted. For example, edges of the cover 4a may have no PL light passing therethrough due to the configuration, and/or one or more portions of the cover may be made opaque—e.g. by markings printed thereon or a substance embedded within the polymeric cover 4a—whilst still leaving a sufficient clear area to provide the desired glow and light access for charging of the PL material 2. In embodiments in which light transmission through one or more portions of the cover 4a is blocked, the set threshold for light transmission of the material used to form the cover may be higher than in embodiments in which the entire area of the cover 4a is to be available for light transmission.

In some embodiments, especially in embodiments with sleeve-type housings 4, the longitudinally extending layer of photoluminescent material 2 is slidably removable from the housing 4—the PL layer 2 of such embodiments may also be slidably inserted when manufacturing the assembly 1, and may be described as an “insert”. The “insert” 2 and “sleeve” 4 may therefore be easily separated for recycling or re-use. It will be appreciated that one or both ends of the assembly 1 may be hermetically sealed in advance of use (optionally sealed shut, or sealed to an adjacent assembly so as to form a longer track, optionally with an adhesive-which may be cured—or with localised melting of the polymeric casing 4), and that any such sealed ends may be cut off before removing the insert.

In embodiments with other designs of housing 4, assembly and disassembly approaches may be varied—for example, a lid-type cover 4a may be lifted off a base 4b (optionally after dissolving or cutting through an adhesive or other join holding one part to the other) and the PL material 2 may be lifted out or tipped out once the housing 4 has been opened.

In various implementations, as noted above, the assembly 1 extends longitudinally (being elongate in shape) and may be adapted to be connected to a further assembly to form a track 26 that can be fitted to a floor of an aircraft cabin 20 and to extend along an aisle 21 of an aircraft cabin.

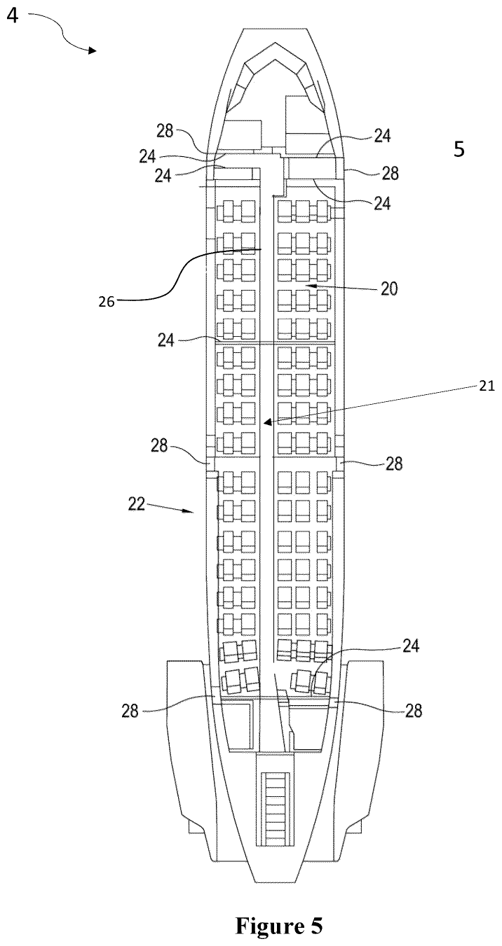

FIG. 5 is a schematic illustration of an aircraft 22 having an aircraft cabin 20 and a number of assemblies 1 connected together to form a track 26 extending along an aisle 21 of the cabin and arranged to guide a passenger from a seat to one or more emergency exits 28. The track 26 may guide passengers around or past one or more internal walls or dividers 24.

As illustrated in FIG. 5, it is intended that the assembly 1 will be utilised in a cabin 20 in an aircraft 22. The assembly 1 may be adapted to be secured to a floor in the cabin 20—for example along an aisle 22 and/or between rows of seats in exit rows.

It has been found that an assembly 1 in accordance with the invention is robust and durable. The rigorously-tested assembly 1 was found to meet all of the stringent performance requirements of an emergency exit way marker in an aircraft cabin even though various features—in particular, the use of a biodegradable additive, the use of recycled material, and/or the use of mixed polymer materials to form a polymeric layer-go against long-held prejudices in the art.

It has been found that using materials as described herein enables the amount of virgin material that is required to be reduced significantly, and so reduces the environmental impact of the assembly. In addition, the cover 4a in accordance with the invention, and optionally the entire housing 4, is biodegradable, so reducing the environmental impact at end-of-life of the assembly 1.

The upper surface 6 of the assembly 1 may be used to show one or more patterns or images, for aesthetic and/or safety reasons—e.g. one or more arrows indicating an exit direction, and/or a pattern to match or complement an aircraft carpet or other flooring may be provided. The housing 4 may therefore be used as a substrate which can be printed on to provide such patterns or images. Alternatively or additionally, an upper surface of the PL layer itself may be printed on to form a desired pattern or symbol (optionally with an opaque ink), and/or a film may be inserted between the PL layer and an underside of the cover 4a, and that film may be a coloured or colourless film (provided that it is not opaque), and may be patterned or printed thereon.

It will be appreciated that the upper surface 6 is required to let light pass therethrough. In some embodiments the upper surface 6 of the assembly 1 comprises at least a first area through which light emitted by photoluminescent material is transmitted and optionally comprises at least a second area through which light from photoluminescent material is not transmitted. In some such embodiments, an opaque ink may be used to form one or more patterns or images, and the opaque ink may not cover the entire surface 6. The opaque ink may be applied to the housing 4, the PL layer, and/or to a film inserted therebetween, in various embodiments.

In alternative or additional embodiments, an ink or other material used to form the printed pattern or image may itself be transparent (e.g. colourless, or coloured transparent) or translucent. In such embodiments, the ink may cover the entire surface 6.

The polymeric material for use in making the housing 4 described herein was found to be suitable for extrusion, and the resultant assembly 1 was found to meet flammability, light transmission, fluid exposure, footwear exposure, temperature range tolerance, and pressure range tolerance requirements for aircraft cabin usage. In addition, the material of the housing 4 was found to be suitable for coating and print adhesion, so allowing for equivalent aesthetics and surface finishes to prior materials. As such, embodiments of the invention allow the sustainability of an aircraft emergency guidance assemblies to be improved whilst maintaining all of the required and desirable properties.

In the embodiments described in detail above, the recycled material is a recycled polymer—i.e. the polymeric material was pre-existing, having been made for a different intended usage, and then processed and used to form the polymeric cover. The recycling process typically comprises chipping or shredding of the virgin (or previously recycled) polymer, washing it (before or after shredding), and re-forming the material into the desired shape. The same polymer chains are re-used. The virgin (or previously recycled) polymer may be reprocessed through any suitable recycling method. These recycling methods include, but are not limited to, mechanical methods such as chipping, shredding, or melting.

In some alternative or additional embodiments, the material of the casing 4 is made using polycarbonates formed from monomers generated as waste products, and optionally is a blend of virgin polycarbonates made directly from fossil fuel sources and the polycarbonates formed from such waste monomers (so recycling the monomers to make new polymers). In these embodiments, the recycled material therefore is or comprises a polymer derived from monomers that are considered as waste or processing residue from other industrial or chemical processes. For example, the recycled material may be Makrolon® 6557 or Makrolon® LED5902 FR RE, or another polymeric material formed from bio-circular monomer feedstocks or similar, whilst having suitable mechanical properties and light transmittance. The polymer formed from these waste monomers can be formed with a standard pellet size, so reducing or avoiding issues arising from varied pellet sizes when working with recycled polymers.

The monomers, that otherwise may have been discarded, may be reclaimed and purified for use in new polymerisation reactions. New polymer chains are created using the same monomers. The reclaimed monomers may be waste of biological origin such as waste from agriculture, forestry, or other related industries. The monomers may be reclaimed from the biodegradable fraction of industrial and municipal waste.

It will be appreciated that, recycled material origin aside, the features and requirements of embodiments using reclaimed monomers may be generally the same as those for embodiments using recycled polymers as described above. Further, some embodiments may use a mixture of both types of recycled material to provide some or all of the polymeric component of the cover.

An increase in the proportion of recycled material (and corresponding reduction in the proportion of polymer derived directly from fossil fuels) within the polymeric cover may typically reduce the light transmission through the polymeric cover. As discussed above, an increase in the proportion of biodegradable additive in the polymeric cover may further reduce the light transmission through the polymeric cover.

In some embodiments, the recycled materials made using reclaimed monomers and new polymerisation processes may be clearer than the directly-recycled polymers, and a higher percentage of the recycled material may therefore be usable without diminishing light transmission below acceptable levels.

For example, embodiments of the polymeric cover wherein the recycled material is a polymer formed from monomers generated as a waste product may have up to 85% recycled material by mass, and for example may have 70-85%, 75-83%, or 80-85% recycled material by mass.

In alternative embodiments, wherein the recycled material is a recycled polymer, the polymeric cover may have a lesser loading of recycled material, for example up to 55% recycled material by mass.

For either type of recycled material, or any combination of recycled materials, (i) the loading of the biodegradable additive, and (ii) the proportion of recycled material, may be controlled such that light transmission of the polymeric cover is at least 80%. Typically, the loading of the additive may be decreased as the proportion of recycled material is increased.

It will be appreciated that the embodiments described in detail herein are given by way of illustrative example only, and not intended to be limiting. The scope of the invention is to be limited only by the appended claims.

What is claimed is:

1. An aircraft emergency guidance assembly arranged to be mounted in an aircraft cabin, wherein the assembly comprises a longitudinally extending layer of photoluminescent material and a housing arranged to protect the photoluminescent material, the housing comprising a polymeric cover arranged to cover the layer of photoluminescent material, and wherein the polymeric cover comprises:
at least 20% recycled material by mass; and
a biodegradable additive, with a loading of the biodegradable additive of between 0.01% and 0.20% by mass, and wherein the loading of the biodegradable additive is set such that light transmission of the polymeric cover is at least 80%.

2. The aircraft emergency guidance assembly of claim 1, wherein the recycled material is a recycled polymer.

3. The aircraft emergency guidance assembly of claim 1, wherein the recycled material is a polymer formed from monomers generated as a waste product.

4. The aircraft emergency guidance assembly of claim 1, wherein the recycled material is colourless polycarbonate.

5. The aircraft emergency guidance assembly of claim 1, wherein the polymeric cover comprises at least 45% virgin polymer.

6. The aircraft emergency guidance assembly of claim 1, wherein the loading of the biodegradable additive is between 0.01% and 0.10% by mass.

7. The aircraft emergency guidance assembly of claim 1, wherein the recycled material is a recycled polymer, and the polymeric cover comprises 45 to 55% recycled polymer by mass and between 0.01% and 0.10% biodegradable additive by mass.

8. The aircraft emergency guidance assembly of claim 7, wherein the polymeric cover comprises 45 to 55% virgin polymer by mass.

9. The aircraft emergency guidance assembly of claim 1, wherein the recycled material is a polymer formed from monomers generated as a waste product, and the polymeric cover comprises 70 to 95% recycled material by mass and between 0.01% and 0.10% biodegradable additive by mass.

10. The aircraft emergency guidance assembly of claim 1, wherein light transmission through the polymeric cover is at least 85% of incident light.

11. The aircraft emergency guidance assembly of claim 10, wherein the loading of the biodegradable additive in the polymeric cover is set by adding biodegradable additive until light transmission through the polymeric cover drops to 90% of incident light.

12. The aircraft emergency guidance assembly of claim 1, wherein an underside of the housing is arranged to be secured to the floor of an aircraft cabin.

13. The aircraft emergency guidance assembly of claim 1, wherein the cover comprises at least a first area through which light emitted by photoluminescent material is transmitted.

14. The aircraft emergency guidance assembly of claim 1, wherein the assembly is adapted to be connected to a further assembly to form a track adapted to be fitted to a floor of an aircraft cabin and to extend along an aisle of an aircraft cabin.

15. The aircraft emergency guidance assembly of claim 1, wherein the polymeric cover comprises at least one colourless polymer selected from polypropylene, polycarbonate, polymethyl methacrylate, and polyurethane, and wherein at least one of the polymers forms at least a portion of the recycled material.

16. The aircraft emergency guidance assembly of claim 1, wherein the longitudinally extending layer of photoluminescent material is slidably removable from the housing.

17. The aircraft emergency guidance assembly of claim 1, wherein the housing is a single-piece housing made of the same material, with the cover forming an integral part of the single-piece housing.

18. The aircraft emergency guidance assembly of claim 1, wherein the housing comprises at least two parts made of different materials:
(i) the cover; and
(ii) a polymeric base comprising at least 50% recycled material by mass and a biodegradable additive.

19. An aircraft having an aircraft cabin comprising an aircraft emergency guidance assembly that comprises a longitudinally extending layer of photoluminescent material and a housing arranged to protect the photoluminescent material, the housing comprising a polymeric cover arranged to cover the layer of photoluminescent material, and wherein the polymeric cover comprises:
at least 20% recycled material by mass; and
a biodegradable additive, with a loading of the biodegradable additive of between 0.01% and 0.20% by mass, and wherein the loading of the biodegradable additive is set such that light transmission of the polymeric cover is at least 80%.

20. The aircraft of claim 19, wherein the aircraft cabin comprises at least one track extending along an aisle of the aircraft cabin, the track comprising a plurality of the emergency guidance assemblies connected together.
